(19) United States
(12) Patent Application Publication
(10) Pub. No.: US 2007/0103427 A1
(43) Pub. Date: May 10, 2007

(54) Display apparatus with a display device and a cyclic rail-stabilized method of driving the display device

(75) Inventors: Guofu Zhou, Eindhoven (NL); Ara Knaian, Cambridge, CA (US); Karl Raymond Amundson, Cambridge, CA (US); Alexander Victor Henzen, Heerlen (NL); Johannes Petrus Van De Kamer, Heerlen (NL); Robert Waverly Zehner, Arlington, CA (US); Benjamin D. Zion, State College, PA (US); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronice N.V.

(21) Appl. No.: 10/580,059

(22) PCT Filed: Nov. 23, 2004
(86) PCT No.: PCT/IB04/52512

§ 371 Date: May 22, 2006

(30) Foreign Application Priority Data
Nov. 25, 2003 (EP) 03104355.7

(51) Int. Cl. G09G 3/34

(52) U.S. Cl. 345/107

(57) ABSTRACT

A cyclic rail-stabilized method of driving an electrophoretic display device (1), wherein a substantially dc-balanced driving waveform is used to effect the various required optical transitions. The driving waveform consists of a plurality of picture potential differences (20), which cause the charged particles (6) of the electrophoretic device (1) to cyclically between extreme optical positions in a single optical path, irrespective of the image sequence required to be displayed, i.e. in order to display each grey scale, it is necessary for the particles (6) to first pass through one of the extreme optical states. In order to minimise the effects of dwell time on the image quality and minimise, or even eliminate, the need to consider image history, shaking pulses (10) are generated immediately prior to each picture potential difference (20).

This invention relates to a display apparatus, comprising:
an electrophoretic medium comprising charged particles in a fluid;
a plurality of picture elements;
said charged particles being able to occupy a plurality of positions, two of said positions being extreme positions and at least one position being an intermediate position between the two extreme positions; and
drive means arranged to supply a sequence of picture potential differences to each of said picture elements so as to cause said charged particles to occupy one of said positions for displaying an image.

An electrophoretic display commonly comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause it to occupy a position between the electrodes, depending on the value and duration of the applied potential difference, so as to display a picture.

In more detail, such an electrophoretic display device is a matrix display with a matrix of pixels which area associated with intersections of crossing data electrodes and select electrodes. A grey level, or level of colourisation of a pixel, depends on the time a drive voltage of a particular level is present across the pixel. Dependent on the polarity of the drive voltage, the optical state of the pixel changes from its present optical state continuously towards one of the two extreme situations, e.g. one type of all charged particles is near the top or near the bottom of the pixel. Grey scales are obtained by controlling the time the voltage is present across the pixel.

Usually, all of the pixels are selected line by line by supplying appropriate voltages to the select electrodes. The data is supplied in parallel via the data electrodes to the pixels associated with the selected line. If the display is an active matrix display, the select electrodes control active elements for example TFT's, MIM's, diodes, which in turn allow data to be supplied to the pixel. The time required to select all the pixels of the matrix display once is called the sub-frame period. A particular pixel either receives a positive drive voltage, a negative drive voltage, or a zero drive voltage during the whole sub-frame period, dependent on the change in optical state required to be effected. A zero drive voltage is usually applied to a pixel if no change in optical state is required to be effected.

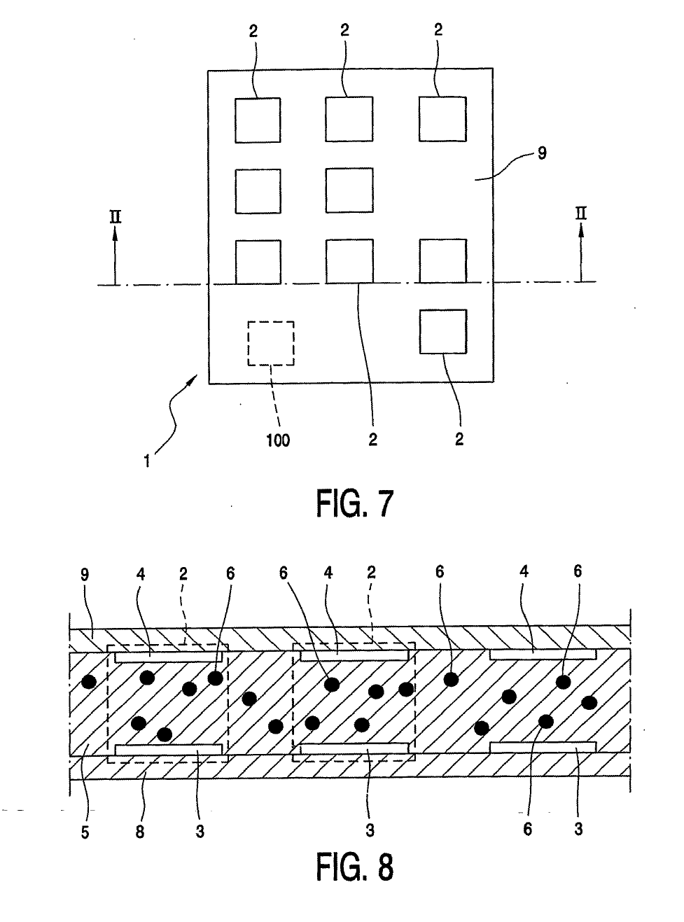

FIGS. 7 and 8 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure. In another embodiment, the picture elements 2 might be arranged in a honeycomb arrangement.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 8, the first substrate 8 has for each picture element 2 a first electrode 3, and the second substrate 9 has for each picture element 2 a second electrode 4. The charged particles 6 are able to occupy extreme positions near the electrodes 3, 4, and intermediate positions between the electrodes 3, 4. Each picture element 2 has an appearance determined by the position of the charged particles 6 between the electrodes 3, 4.

Electrophoretic media are known per se from, for example, U.S. Pat. No. 5,961,804, U.S. Pat. No. 6,120,839 and U.S. Pat. No. 6,130,774, and can be obtained from, for example, E Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

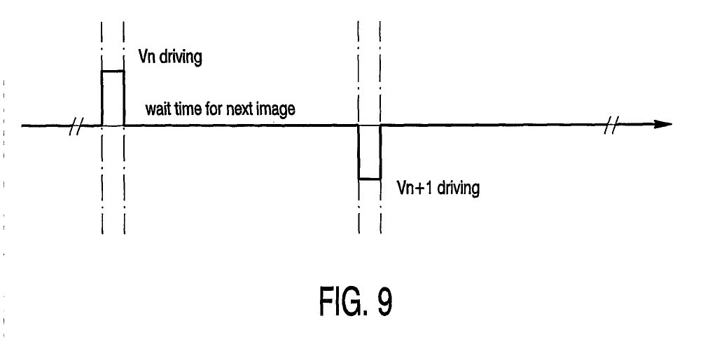

FIG. 9 illustrates part of a typical conventional random greyscale transition sequence using a voltage modulated transition matrix. Between the image state n and the image state n+1, there is always a certain time period (dwell time) available which may be anything from a few seconds to a few minutes, dependent on different users.

In general, in order to generate grey scales (or intermediate colour states), a frame period is defined comprising a plurality of sub-frames, and the grey scales of an image can be reproduced by selecting per pixel during how many sub-frames the pixel should receive which drive voltage (positive, zero, or negative). Usually, the sub-frames are all of the same duration, but they can be selected to vary, if desired. In other words, typically grey scales are generated by using a fixed value drive voltage (positive, negative, or zero) and a variable duration of drive periods.

In a display using an electrophoretic medium, layers in addition to the electrophoretic medium (for example, a layer of lamination adhesive) are typically present between the electrodes. Some of these layers are substantially insulating layers, which layers become charged as a result of the potential differences. The charge present at the insulating layers is determined by the charge initially present at the insulating layers and the subsequent history of the potential differences. Therefore, the positions of the particles depend not only on the potential differences being applied, but also on the history of the potential differences. As a result, significant image retention can occur, and the pictures subsequently being displayed according to image data differ significantly from the pictures which represent an exact representation of the image data.

As stated above, grey levels in electrophoretic displays are generally created by applying voltage pulses for specified time periods. They are strongly influenced by image history, dwell time, temperature, humidity, lateral inhomogeneity of the electrophoretic layers, etc. In order to consider the effect of image history, driving schemes based on the transition matrix have been proposed. In such an arrangement, a matrix look-up table (LUT) is required, in which driving signals for a greyscale transition with different image history are predetermined. However, build up of remnant dc voltages after a pixel is driven from one grey level to another is unavoidable because the choice of the driving voltage level is generally based on the requirement for the grey value. The remnant dc voltages, especially after integration after multiple greyscale transitions, may result in additional image retention and shorten the life of the display.

It is an object of the present invention to provide a display apparatus and a method of driving such apparatus, in which the effects of dwell time and image history with regard to image quality are significantly reduced, such that accurate greyscale can be achieved without the need for consideration of any previous images, or considering only a minimal number of such images.

In accordance with the present invention, there is provided display apparatus comprising an electrophoretic medium comprising charged particles in a fluid; a plurality of picture elements; said charged particles being able to occupy a plurality of positions, two of said positions being extreme positions and at least one position being an intermediate position between the two extreme positions; and drive means arranged to supply a sequence of picture potential differences to each of said picture elements so as to cause said charged particles to occupy one of said positions for displaying an image; wherein said sequence of picture potential differences form a driving waveform for causing said charged particles to move cyclically between said extreme positions in a single optical path and effect a desired optical transition along said optical path, said picture potential differences being preceded by one or more shaking pulses. A shaking pulse is defined as a single polarity voltage pulse representing an energy value wherein the energy value (defined as the integration of voltage pulse with time) of the or each shaking pulse is sufficient to release the particles at one of the extreme positions but insufficient to move the particles from one of the extreme positions to the other.

The picture potential differences are preferably preceded by at least two, and more preferably four or more shaking pulses. The length of the or each shaking pulse is beneficially of an order of magnitude shorter than a minimum time period required to drive the optical state of the apparatus from one of the extreme positions to the other. The energy value of the or each shaking pulse is beneficially sufficient to release particles at one of the two extreme positions but insufficient to significantly change the optical state of the apparatus, in particular insufficient to move the particles from one extreme position to the other extreme position between the two electrodes.

The driving waveform may, for example be, pulse width modulated or voltage-amplitude modulated, and is preferably substantially dc-balanced on average (over a relatively long term).

Also in accordance with the present invention, there is provided a method of driving a display apparatus, comprising an electrophoretic medium comprising charged particles in a fluid, a plurality of picture elements, said charged particles being able to occupy a plurality of positions, two of said positions being extreme positions and at least one position being an intermediate position between the two extreme positions; and drive means arranged to supply a sequence of picture potential differences to each of said picture elements so as to cause said charged particles to occupy one of said positions for displaying an image; the method comprising generating the sequence of picture potential differences in the form of a driving waveform for causing said charged particles to move cyclically between said extreme positions in a single optical path and effect a desired optical transition along said optical path, and providing one or more shaking pulses prior to each of said picture potential differences.

Still further in accordance with the present invention, there is provided drive means for driving a display apparatus as defined above, said drive means being arranged to supply the sequence of picture potential differences to each of said picture elements so as to cause said charged particles to occupy one of said positions for displaying an image; wherein said sequence of picture potential differences form a driving waveform for causing said charged particles to move cyclically between said extreme positions in a single optical path, said picture potential differences being preceded by one or more shaking pulses.

These and other aspects of the present invention will be apparent from, and elucidated with reference to, the embodiments described hereinafter.

Embodiments of the present invention will now be described by way of examples only and with reference to the accompanying drawings, in which:

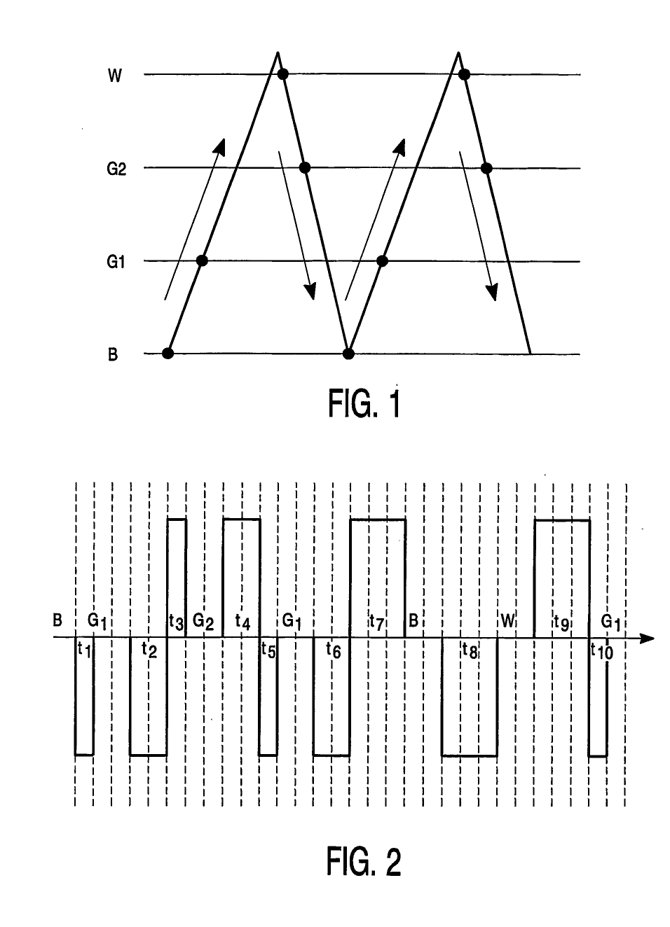

FIG. 1 illustrates schematically a cyclic rail-stabilized driving method for an electrophoretic display having four optical states: white (W), light grey (G2), dark grey (G1) and black (B);

FIG. 2 illustrates a driving waveform for performing optical transitions, in which three items of image history are illustrated for a transition to G1;

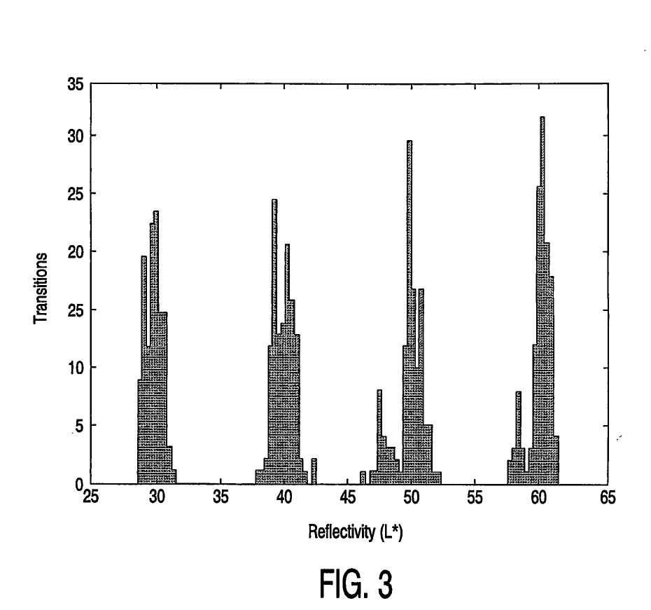

FIG. 3 illustrates experimental results obtained with the waveform of FIG. 2;

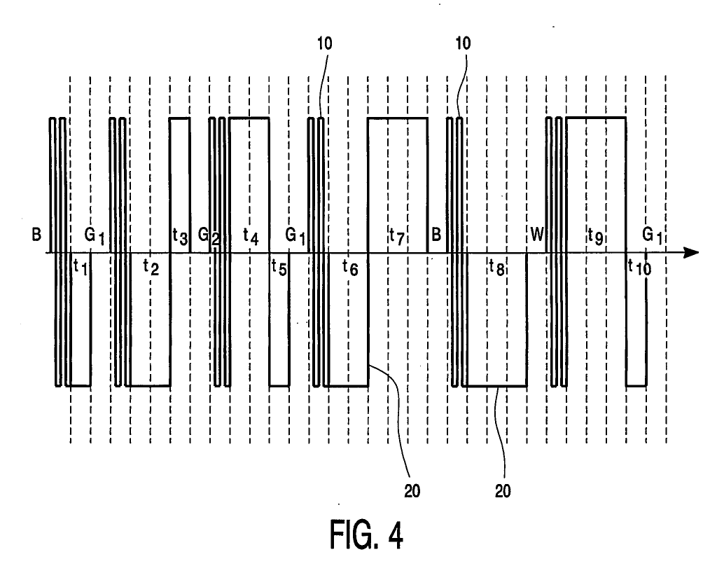

FIG. 4 illustrates a driving waveform for performing optical transitions according to a first exemplary embodiment of the present invention;

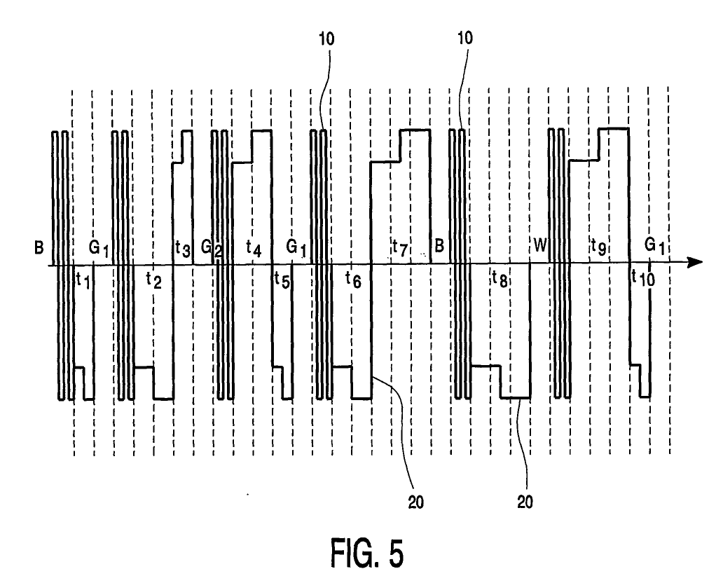

FIG. 5 illustrates a driving waveform for performing optical transitions according to a second exemplary embodiment of the present invention;

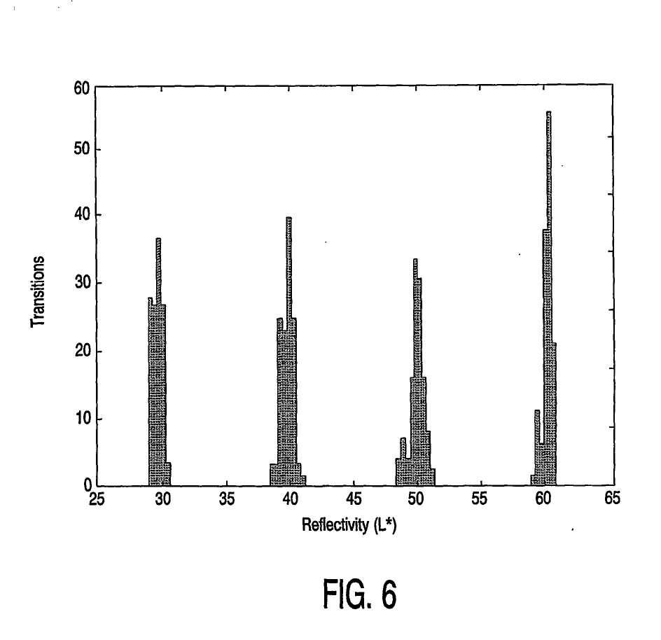

FIG. 6 illustrates experimental results obtained with the waveform of FIG. 5;

FIG. 7 is a schematic front view of a display panel according to an exemplary embodiment of the present invention;

FIG. 8 is a schematic cross-sectional view along II-II of FIG. 7; and

FIG. 9 illustrates part of a typical greyscale transition sequence using a voltage modulated transition matrix according to the prior art.

Thus, as explained above, grey levels in electrophoretic displays are strongly influenced by image history, dwell time, temperature, humidity, lateral inhomogeneity of the electrophoretic layers, etc. It has been demonstrated that accurate grey levels can be achieved using a so-called rail-stabilized approach. This means that the grey levels are always achieved via one of the two extreme optical states (say black or white) or “rails”, irrespective of the image sequence itself.

In order to achieve substantially dc-balanced driving, a cyclic rail-stabilized greyscale concept has recently been proposed, and it is illustrated schematically in FIG. 1 of the drawings. In this method, as stated above, the “ink” must always follow the same optical path between the two extreme optical states, say full black or full white (i.e. the two rails), regardless of the image sequence, as indicated by the arrows in FIG. 1. In the illustrated example, the display has four different states: black (B), dark grey (G1), light grey (G2) and white (W).

The corresponding driving waveform for effecting the illustrative image transitions is illustrated schematically in FIG. 2, and it will be appreciated that, for the sake of simplicity, a pulse width modulated (PWM) driving scheme is utilized in this particular example, and a display having ideal ink materials (i.e. insensitive to dwell time and image history) is assumed.

Due to the cyclic character of the driving method, the total energy (expressed by time×voltage) involved in a negative pulse, is always equal to that of the subsequent positive pulses.

For example, assume that the current image is in the black state, and the next image to be displayed is dark grey (G1). In this case, a negative voltage pulse with ⅓ of the full pulse width (t₁) is applied (bearing in mind that the “full pulse width” is the pulse width required to change state from full black to full white, or vice versa, so ⅓ of the pulse width, having a negative polarity, is required to move the particles upwards from full black to G1). After a waiting period (dwell time), image G2 needs to be displayed on the pixel. A negative pulse width with ⅔ of the full pulse width (t₂) is used (to reach the full white state), directly followed by a positive pulse with ⅓ of the full pulse width (t₃) to reach G2. Next, the G1 state is required to be displayed after another dwell time. A positive pulse with ⅔ of the full pulse width (t₄) is used, to reach the full black state, directly followed by a negative pulse with ⅓ of the full pulse width (t₅) to reach G1 from there.

Thus, the ink always follows the arrows, such that: t1+t2=t3+t4=t5+t6=t7=t8=t9 . . . . In this manner, a DC-balanced driving method is realised when a pulse-width modulated (PWM) driving scheme is applied and ideal ink is used. When other driving schemes like voltage modulated (VM) driving schemes or combined PWM and VM driving schemes are used and ink is not ideal, the DC balance is achieved by adhering to impulse potential theory: the waveform is constructed so that there is no net impulse for all sets of transitions that bring the display from any initial state, through an arbitrary set of states, and back to the initial state.

However, the waveform illustrated in FIG. 2 requires the use of a very complex transition matrix, in which at least five previous images are required to determine the impulse required to display the next image. This consumes a lot of power, as well as being costly. In addition, because the effect of dwell time is not minimised in the technique described above, there is a detrimental effect on the accuracy of the greyscale.

Referring to FIG. 3 of the drawings, there is illustrated representative experimental results obtained using the voltage modulated driving waveform illustrated in FIG. 2, without taking into account the previous images: i.e. only the current image (R1) and the immediate previous image (R2) are considered. It should be noted that, in the experiments performed to obtain the results of FIG. 3, a tune sequence with a constant dwell time of 2 seconds was first used for obtaining the correct look-up table, which was used for another sequence with random image transitions. The four grey levels 30, 40, 50 and 60 are obtained with a precision of 4.9L*, which, as a person skilled in the art will appreciate, is obviously not favourable.

Thus, the present invention provides an improved cyclic rail-stabilized driving method (and an active matrix electrophoretic display apparatus utilising such a method). In a preferred embodiment, the display has at least two discrete grey levels, as well as the two extreme levels adjacent the respective electrodes. The term “cyclic rail-stabilized” in the sense of the present invention is intended to mean that the charged particles (i.e. the “ink”) must always follow the same optical path between the two extreme levels or states (i.e. the two rails), say fully black and fully white, regardless of the image sequence, as described with reference to FIG. 1. Thus, greyscale driving pulses are used to drive the display, following the cyclic rail-stabilized principle, and shaking pulses are additionally provided, preferably immediately preceding each driving pulse. The length of a shaking pulse is preferably an order of magnitude shorter than the minimum time period (otherwise known as the “saturation time”) required for driving the display from the full black to the full white state.

The provision of shaking pulses significantly reduces the effects of dwell time and image history with regard to image quality, such that accurate greyscale can be achieved without the need for consideration of any previous images, or considering only a minimal number of such images.

In a first exemplary embodiment of the invention, the pulse width modulated (PWM) method of driving is used, i.e. constant voltage amplitude and variable pulse duration), and the corresponding driving waveform which can be used to achieve the image sequence illustrated in FIG. 1, is illustrated schematically in FIG. 4 of the drawings.

As shown, for each image transition, four shaking pulses 10 are used immediately prior to each impulse 20 required to effect greyscale driving, and the length of a single shaking pulse is an order of magnitude shorter than the minimum time period required for driving the display from full black to full white (i.e. the saturation time). The energy involved in a shaking pulse should be insufficient to move the particles by any significant distance, such that the effects of dwell time and image history can be significantly reduced and optical disturbance (flicker) minimised.

In a second exemplary embodiment of the present invention, a voltage modulated (VM) driving method may be used (i.e. variable voltage amplitude). The corresponding driving waveform as illustrated schematically in FIG. 5 for achieving the same image transitions as shown in FIG. 1 of the drawings. It has been demonstrated that voltage modulated driving, particularly using a stair-up impulse as shown in FIG. 5, may give the best results.

Once again, in these transitions, four shaking pulses 10 are used immediately prior to the impulse 20 required for the greyscale driving in respect of each image transition. -As in the case of the first exemplary embodiment described-above, the energy involved in a shaking pulse should be sufficiently high to be able to release the particles locally but should be insufficient to move the particles any significant distance.

It has been experimentally demonstrated that accurate greyscale can be obtained without considering the image history. In fact, representative experimental results without considering the previous images: i.e. only the current image (R1) and the immediate previous image (R2) are considered, are illustrated in FIG. 6 of the drawings, using the voltage modulated driving waveform illustrated in FIG. 5. Once again, in the experiments performed to obtain the results illustrated in FIG. 6, a constant dwell time of 2 seconds was first used for obtaining the correct look-up table, which was then used for another sequence with random image transitions. Four shaking pulses with a pulse length of 20 ms were applied prior to each driving impulse. The four grey levels 30, 40, 50 and 60 were obtained with a precision of 2.3L*, i.e. the maximum error at the bottom of the histogram is 2.3L*, which is a significant improvement over the result achieved with the waveform illustrated in FIG. 2 and demonstrated in FIG. 3. In fact, at least one previous image is required to be considered to obtain similar results with the waveform of FIG. 2, in which no shaking pulses are used.

Note that the invention may be implemented in passive matrix as well as active matrix electrophoretic displays. Also, the invention is applicable to both single and multiple window displays, where, for example, a typewriter mode exists. This invention is also applicable to colour bi-stable displays. Also, the electrode structure is not limited. For example, a top/bottom electrode structure, honeycomb structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. Display apparatus (1), comprising:
an electrophoretic medium (5) comprising charged particles (6) in a fluid;
a plurality of picture elements (2);
said charged particles (6) being able to occupy a plurality of positions, two of said positions being extreme positions and at least one position being an intermediate position between the two extreme positions; and
drive means arranged to supply a sequence of picture potential differences (20) to each of said picture elements (2) so as to cause said charged particles (6) to occupy one of said positions for displaying an image; wherein said sequence of picture potential differences (20) form a driving waveform for causing said charged particles (6) to move cyclically between said extreme positions in a single optical path and effect a desired optical transition along said optical path, said picture potential differences (20) being preceded by one or more shaking pulses (10).

2. Display apparatus (1) according to claim 1, comprising:
a first (3) and a second electrode (4) associated with each picture element (2) for receiving the sequence of picture potential differences (20), the extreme positions being substantially adjacent said electrodes (3, 4) and the intermediate position being between said electrodes (3, 4).

3. Display apparatus (1) according to claim 1, having at least two intermediate positions.

4. Display apparatus (1) according to claim 1, wherein the picture potential differences (20) are preceded by at least two shaking pulses (10).

5. Display apparatus (1) according to claim 4, wherein the picture potential differences (20) are preceded by four or more shaking pulses (10).

6. Display apparatus (1) according to claim 1, wherein the length of the or each shaking pulse (20) is of an order of magnitude shorter than a minimum time period required to drive the optical state of the apparatus from one of said extreme positions to the other.

7. Display apparatus (1) according to claim 1, wherein the energy value (defined as the integration of voltage pulse with time) of the or each shaking pulse is sufficient to release the particles at one of the extreme positions but insufficient to move the particles from one of the extreme positions to the other.

8. Display apparatus (1) according to claim 1, wherein said driving waveform is pulse width modulated.

9. Display apparatus (1) according to claim 1, wherein said driving waveform is voltage modulated.

10. Display apparatus (1) according to claim 1, wherein said driving waveform is substantially dc-balanced on average (over a relatively long term).

11. A method of driving a display apparatus (1), comprising an electrophoretic medium (5) comprising charged particles (6) in a fluid, a plurality of picture elements (2), said charged particles (6) being able to occupy a plurality of positions, two of said positions being extreme positions and at least one position being an intermediate position between the two extreme positions; and drive means arranged to supply a sequence of picture potential differences (20) to each of said picture elements so as to cause said charged particles (6) to occupy one of said positions for displaying an image; the method comprising generating the sequence of picture potential differences (20) in the form of a driving waveform for causing said charged particles (6) to move cyclically between said extreme positions in a single optical path and effect a desired optical transition along said optical path, and providing one or more shaking pulses (10) prior to each of said picture potential differences (20).

12. Drive means for driving a display apparatus (1) according to claim 1, said drive means being arranged to supply the sequence of picture potential differences (20) to each of said picture elements (2) so as to cause said charged particles to occupy one of said positions for displaying an image; wherein said sequence of picture potential differences (20) form a driving waveform for causing said charged particles (6) to move cyclically between said extreme positions in a single optical path, said picture potential differences (20) being preceded by one or more shaking pulses (10).
